(19) United States
(12) Patent Application Publication
(10) Pub. No.: US 2005/0253371 A1
(43) Pub. Date: Nov. 17, 2005

(54) Scrapbooking supplies system

(76) Inventor: Gwenn M. Connolly, Dayton, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/844,146

(22) Filed: May 12, 2004

(51) Int. Cl. B42F 5/00

(52) U.S. Cl. 281/22

(57) ABSTRACT

A scrapbooking supplies system including a backing panel including at least two main panel sections that are foldable relative to each other, and a plurality of different types of scrapbooking components coupled to the backing panel. Each of the scrapbooking components of the plurality of different types of scrapbooking components can be manually separated from the backing panel for use separate and apart from the backing panel.

The present invention is directed to a scrapbooking system including different types of scrapbooking supplies or components coupled to a backing panel.

### BACKGROUND

Activities involving mounting, cataloging, documenting, storing, journaling and decorating of various memorabilia, pictures, keepsakes and the like, also known as scrapbooking activities, are becoming increasing popular. Scrapbookers utilize a wide variety of scrapbooking tools, supplies and components in their scrapbooking activities. Accordingly, retailers are increasingly offering various scrapbooking supplies for purchase.

Some existing retailers loosely package a plurality of scrapbooking supplies in a bag for purchase as a unit. However, the packaging of the scrapbooking supplies in this manner presents a disorganized appearance, and it can be difficult for a potential purchaser to quickly and easily visually determine the contents of such a package. Accordingly, there is a need for an improved system for displaying scrapbooking supplies for sale.

### SUMMARY

The present invention is a scrapbooking supply system which presents the scrapbooking supplies offered for sale in a neat and orderly arrangement, and allows quick visual determination of the contents of the supplies being offered for sale. In particular, in one embodiment the invention is a scrapbooking supplies system including a backing panel including at least two main panel sections that are foldable relative to each other, and a plurality of different types of scrapbooking components coupled to the backing panel. Each of the scrapbooking components of the plurality of different types of scrapbooking components can be manually separated from the backing panel for use separate and apart from the backing panel.

In another embodiment the present invention is a method for selling scrapbooking supplies including providing a system including a backing panel having at least two main panel sections that are foldable relative to each other and a plurality of types of scrapbooking components coupled to an inner surface of the backing panel. The plurality of types of scrapbooking components can be manually separated from the backing panel after purchase by an end user for use separate and apart from the backing panel. At least one representative scrapbooking component of each of the plurality of types of scrapbooking components is visible to a potential purchaser upon inspection and manipulation of the backing panel. The method further includes displaying the system for retail sale such that a potential purchaser can fold and unfold the two main panel sections and inspect the plurality of types of scrapbooking components.

Other objects and advantages of the present invention will be apparent from the following description and the accompanying drawings.

### BRIEF DESCRIPTION OF THE DRAWINGS

FIG. 1 is a front perspective view of one embodiment of the system of the present invention, shown in its closed position;

FIG. 2 is a front perspective view of the system of FIG. 1, shown in its open position;

FIG. 3 is a front perspective view of the system of FIG. 2, with the die-cut shapes exploded;

FIG. 4 is a front perspective view of the system of FIG. 2, with the end panels pivoted to their open position such that the backing panel is in its extended position;

FIG. 5 is an exploded front perspective view of the system of FIG. 2 illustrating the arrangement and assembly thereof; and

FIG. 6 is an exploded front perspective view of another embodiment of the system of the present invention.

### DETAILED DESCRIPTION

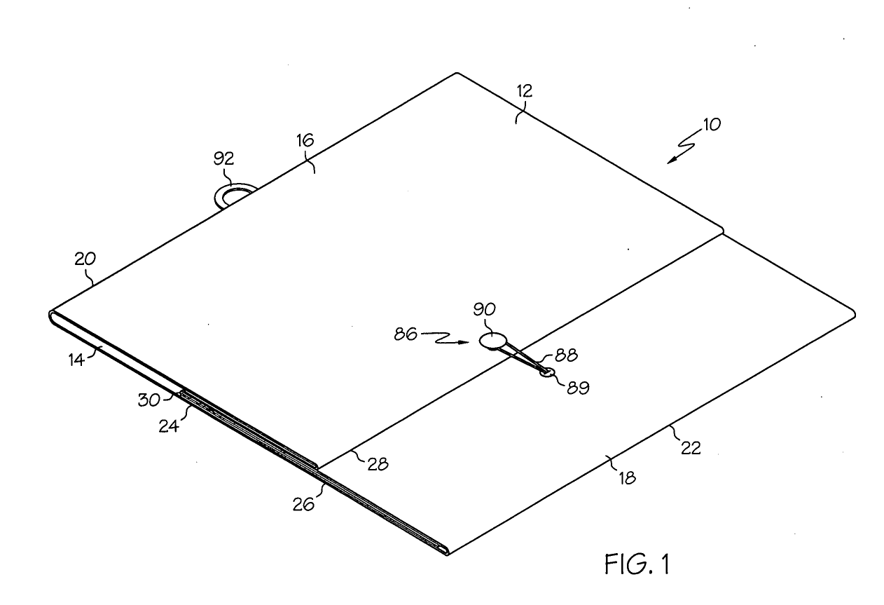

As shown in FIG. 1, the scrapbooking supplies system of the present invention, generally designated 10, includes a backing panel 12 including a center main panel section 14, a left main panel section 16 pivotally attached to the center main panel section 14 along a hinge line or crease line 20, and a right main panel section 18 pivotally coupled to an opposite side of the center main panel section 14 along hinge line or crease line 22. The outer surface of the backing panel 12 may include various decorative indicia, promotional indicia, advertising copy, instructions and scrapbooking tips and hints (not shown) located thereon.

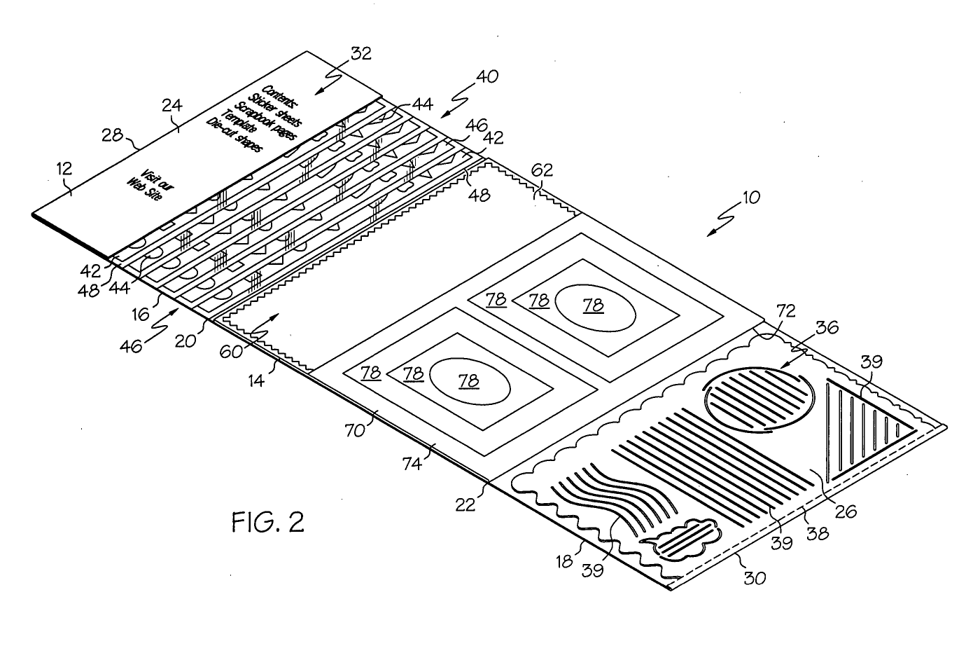

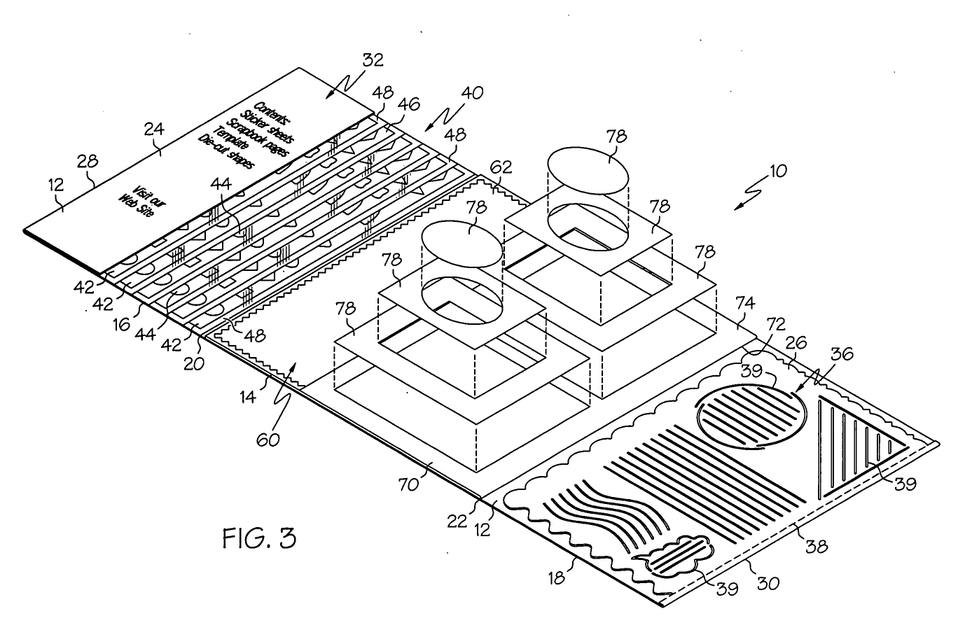

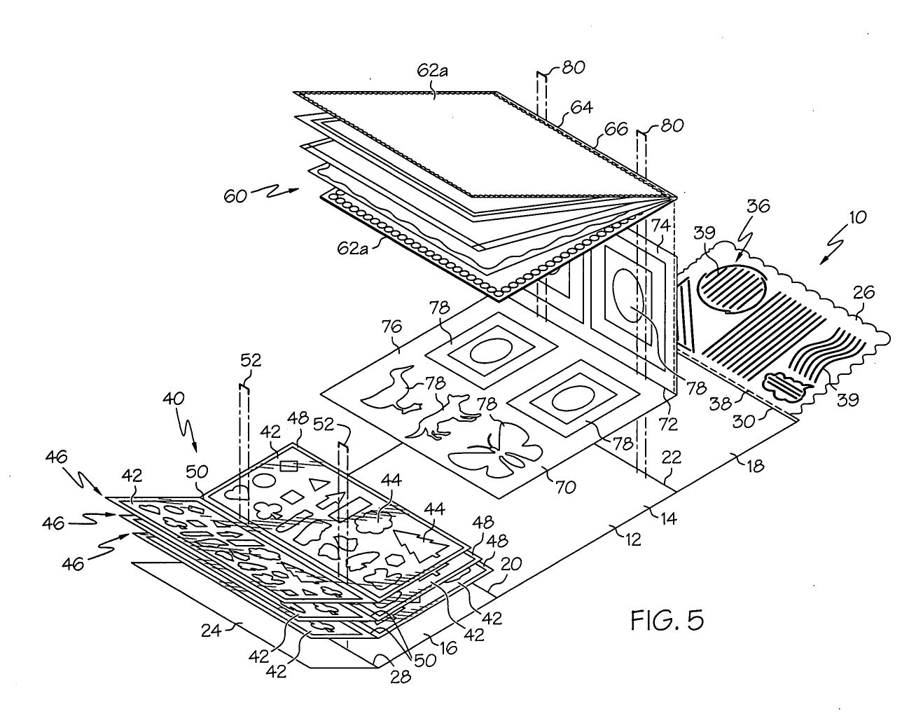

As best shown in FIG. 5, the backing panel 12 further includes a pair of end panels 24, 26, with left end panel 24 being pivotally coupled to left main panel section 16 along hinge line or crease line 28, and right end panel section 26 being pivotally coupled to right main panel section 18 along hinge line 30. Each of the panels 14, 16, 18, 24, 26 and the backing panel 12 as a whole, may be generally rectangular in top view. The backing panel 12 may be made of paper, paperboard, cardboard, plastic or any of a wide variety of suitable materials. The inner surface of the left end panel 24 may include various promotional or instructional indicia or advertising copy 32 (FIGS. 2 and 3) located thereon. Of course, the text and contents of the indicia 32 may vary beyond that specifically shown in the drawings. In addition, both sides of all panels 14, 16, 18, 24 (and, if desired, panel 26) may include various decorative indicia, promotional indicia, advertising copy, instructions and scrapbooking tips and hints (not shown) located thereon.

The backing panel 12 may be moved to or reside in an open or unfolded position (FIGS. 2-4) wherein each of the main panel sections 14, 16, 18 are opened flat and are parallel with each other and do not overlap with one another. The backing panel 12 is also movable to an extended position (FIG. 5) wherein both of the end panels 24, 26 are also fully opened. The backing panel 12 is also movable to a closed position (FIG. 1) wherein the end panels 24, 26 are folded over their respective left 16 and right 18 main panel sections, and the left main panel section 16 and right main panel section 18 are folded over the central main panel section 14.

When the system 10 is in its closed position, the left 16 and right 18 main panel sections at least partly overlap. In the illustrated embodiment, the left main panel section 16 and right main panel section 18 each have a width (i.e., in the left to right direction) less than the width of the central main panel section 14 such that the left main panel section 16 and right main panel section 18 do not fully overlap when the system 10 is in its closed position. In the illustrated embodiment, the left main panel section 16 is configured to lie on top of the right main panel section 18, although this configuration may be reversed if desired.

Right end panel 26 may consist of or include a template, generally designated 36, that is coupled to the right main panel section 18 along tear guideline or perforation line 38. The template 36 may include a series of openings or cut-outs 39 formed therein. In the illustrated embodiment, the openings 39 are formed as a series of straight lines, wavy lines, arcs and the like which can receive the tip of a pen, pencil or the like therethrough to guide the writing instrument during writing. Of course, the openings 39 may have any of a wide variety of shapes and configurations other than those shown herein. The outer edges of the template 36 have scalloped or decorative shapes to provide additional writing guides to a user.

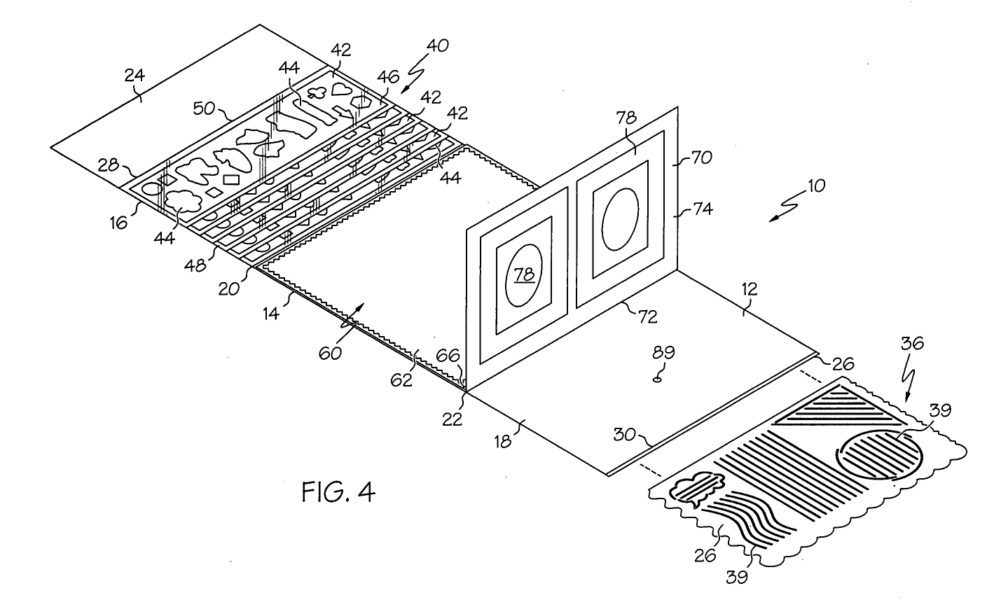

As shown in FIG. 4, the template 36 can be manually torn apart and separated from the backing sheet along the perforation line 38 and used as a component separate and apart from the backing sheet 12. As best shown in FIGS. 2 and 5, the perforation line 38 is located on the right end panel 26 and is spaced slightly away from the fold line 30 such that when the right end panel 26 is folded inwardly, the perforation line 38 is protected to prevent inadvertent tearing along the perforation line 38.

The system 10 may further include a set of sticker sheets or sticker packages, generally designated 40. Each sticker package 40 may include a first and a second label sheet portion 42, each label sheet portion 42 having a set of stickers 44 located thereon. In particular, each label sheet portion 42 may include a release liner with an adhesive sheet located on either side thereof, with die-cut sticker shapes 44 formed in the adhesive sheet to form sticker sheets in the well-known manner. The sticker shapes 44 illustrated in FIGS. 2-5 include various decorative shapes as examples of stickers although it should be understood that any of a wide variety of shapes and colors of stickers may be provided on the sticker sheets.

The embodiment shown in FIG. 5 includes three stacked sticker packages 46, with each sticker package 46 including first and second label sheet portions 42 arranged in a side-by-side configuration. Each sticker package 46 further includes clear packaging 48, such as a cellophane bag, wrap or the like fit around the first and second label sheet portions 42. Each of the first and second label sheet portions 42 may be spaced apart from each other such that each sticker package 42 includes a hinge line 50 extending between the first and second label sheet portions 42. However, if desired the sticker packages 46 and/or label sheet portions 42 may be packaged in a wide variety of manners other than that specifically disclosed herein.

In the illustrated embodiment, the sticker packages 46 are stacked or arranged in a “book-like” or nested configuration such that each of their hinge lines 50 are aligned. As shown in FIG. 5, a sticker sheet binding mechanism 52, such as saddle stitches, staples (illustrated in FIG. 5), adhesives, cords, ties, prongs, spiral or coil binding mechanisms, etc. extends through the aligned hinge lines 50 to couple the sticker packages 46 to the hinge line 28 of the backing panel 12.

In the illustrated embodiment, the sticker packages 46 are arranged in a “tiered” or “stair step” arrangement such that the width (i.e., in the left-to-right direction) of each sticker package 46 is less than the width of the sticker package located immediately below. In this manner, the outer edge (i.e., right hand edge) of each sticker package 46 protrudes and remains visible. Of course, the number of sticker packages 46 may vary from that shown, and more or less sticker packages 46 (including only two sticker packages 46) may be utilized.

The system 10 may include a set of scrapbooking pages or sheets, generally designated 60. In one embodiment, the scrapbooking pages 60 can be made of a standard weight paper, although the scrapbooking pages 60 can be made of any of a wide variety of other weights and materials. Any number of scrapbooking pages 60 may be included, although between about ten and about thirty pages may be preferred.

In the illustrated embodiment, each scrapbooking page 60 includes a decorative border which can be any of a wide variety of varying designs. As shown in FIG. 5, different ones of the scrapbooking pages may include different decorative indicia about their edges. However, the scrapbooking pages 60 may each include different decorative indicia than that shown herein, and may also lack any decorative features. The scrapbooking pages 60 may include indicia at locations other than their outer edges (i.e. in the central portions thereof) and may include decorative indica on only one side thereon. The scrapbooking pages 60 may also be provided in a variety of colors.

Each scrapbooking page 60 may be part of a large sheet 62. In particular, each scrapbooking page 60 may be about one-half of a large sheet 62 which is folded about itself along a center crease or fold line 64. A plurality of large sheets 62 may be folded and nested in the manner shown in FIG. 5, in which the outermost large sheet is labelled 62a. Each large sheet 62 may include a pair of parallel perforation or tear guidelines 66, with each perforation line 66 being located immediately adjacent to, and parallel to, the associated center crease line 64. In this manner, each scrapbooking page 60 can be torn along its perforation line 66 to provide a separated, removed scrapbooking page 60 for use separate and apart from the backing panel 12.

Each removed scrapbooking page 60 may have dimensions of about 12 inches by about 12 inches. The scrapbooking pages 60 may have various sizes and shapes, including about 8½ inches by about 11 inches, and about 8 inches by about 8 inches, or other sizes or shapes. In this manner, each scrapbooking page 60 can be utilized in standard scrapbooking books sleeves that are sized to closely receive papers having these dimensions.

The system 10 may include a die-cut sheet 70 folded at a die-cut sheet fold line or crease 72 to divide the die-cut sheet 70 into a top portion 74 and a bottom portion 76 (FIG. 5). The bottom portion 76 may have roughly the same dimension as the center main panel section 14 to provide additional stiffness and support to that section 14, and to the backing panel 12. The top portion 74 and/or bottom portion 76 of the die-cut sheet 70 may include a set of removable nested die-cut or perforated shapes 78 formed therein. In this manner, the die-cut shapes 78 can be separated from the die-cut sheet 70, and from each other (see FIG. 3), to provide shapes to guide the writing of a user. Certain ones of the die-cut shapes 78 (i.e. the die-cut shapes having rectangular outer dimensions) may also be used as decorative frames for photographs. In particular, each of these die-cut shapes may be glued to a scrapbooking pages and on top of a photograph so that the photograph is visible through the central opening or window thereof. The die-cut shapes 78 may also serve as decorative element which can be glued to scrapbooking pages.

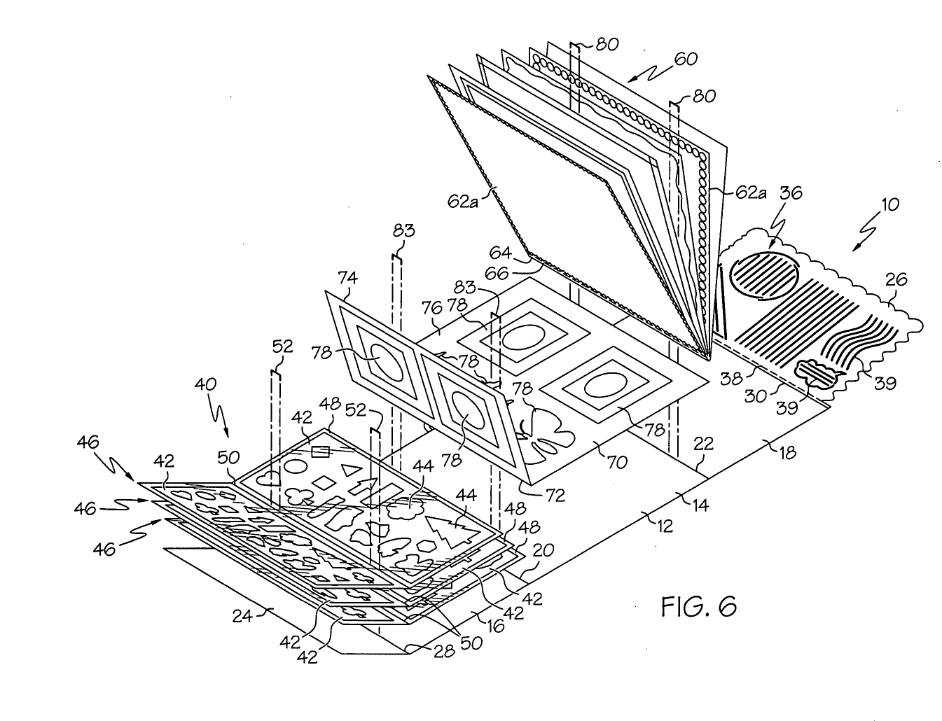

As shown in FIG. 5, the stack of scrapbooking pages 60 may be received in the crease 72 of the die-cut sheet 70 in a nested manner, and the entire subassembly of the scrapbooking pages 60 and die-cut sheet 72 may be attached to fold line 22 of the backing panel 12 by a variety of attachment means. In the illustrated embodiment, saddle stitches or staples 80 are shown, although any of the binding mechanisms discussed above in the context of the sticker packages 46 may also be utilized. Furthermore, when using staples, the staples 80 may extend through the inner edges of the scrapbooking pages 60 and through the center of the die-cut sheet 72 (as shown in FIG. 5). Alternately, the staples 80 may extend through the center crease 66 of the scrapbooking pages, as shown in FIG. 6.

As shown in FIG. 2, when the die-cut sheet 70 and scrapbook pages 60 are assembled, the top portion 74 of the die-cut sheet 70 partially, but not fully, covers the topmost scrapbook page 60 so that part of the topmost page of the scrapbooking pages 60 is exposed. When assembled, the die-cut shapes 78 are fit together and the die-cut shapes of the top portion 74 lie on top of the set of scrapbooking pages 60 such that the set of scrapbooking pages 60 is located between the set of die-cut shapes 78 of the top portion 74 and the center main panel section 14.

Thus, the sticker packages 46 are coupled to backing panel 12 at crease 28, the scrapbooking pages 60 and die-cut sheet 70 are coupled to the backing panel 12 at crease 22, and the template 26 is coupled to the backing panel 12 adjacent to crease 30. In the illustrated embodiment, each of these components 46, 60, 70, 36 lies on top of one of the three main panels 14, 16, 18 when the system 10 is in its open position. When the system 10 is in its open position the sticker packages 46 also lie on top of end panel 24.

As shown in FIG. 1, the system 10 may include a closure mechanism 86 for retaining the system 10 in its closed position. In particular, in the illustrated embodiment the closure mechanism 80 includes an elastic cord 88 coupled to the right end panel section 18 by a small rivet 89, and a rivet or button 90 coupled to the left end panel section 16 such that the elastic cord 88 can be fit around the button 90 to retain the backing panel 12 in its closed position. However, any of a wide variety of retaining mechanisms, including, but not limited to, hook-and-loop fastening material (i.e., VELCRO®), clasps, brackets, clips, magnets, interengaging geometries, cords, ribbon ties, string ties, elastic ties, buttons and elastic closures and the like may be used as the closure mechanism 86.

The system 10 may also include a hook 92 coupled to the backing panel 12 (and in particular along edge 20) such that a hanger or the like may be received therethrough to display the system 10 for purchase. Each of the panels 12, 14, 16, 18, 24, and 26, as well as all of the scrapbooking supplies and components 36, 46, 60, 70, 78 may be made of acid-free paper or materials to avoid damage and prolong the life of pictures, memorabilia and the like utilized with the scrapbooking supplies and components.

FIG. 6 illustrates an alternate embodiment of the invention wherein the die cut sheet 70 is attached along its fold line 72 to the fold line 20 of the backing panel 12 via staples 83. In this embodiment the scrapbooking pages 60 remain coupled to the backing panel 12 along fold line 22 (although the scrapbooking pages 60 may instead by coupled to the backing panel 12 along fold line 20). The scrapbooking pages 60 may be located between the top 74 and bottom 76 portions of the die-cut sheet 70. The shape and arrangement of the die cut sheet 70 (which may be relatively stiff) in the embodiment shown in FIG. 6 may help to ensure that the scrapbooking pages 60 remain folded flat against the backing panel 12 when the system 10 is in certain orientations and configurations.

The shape and arrangement of the system 10 allows for quick and easy inspection by potential purchasers so that the contents of the system can be easily viewed. In particular, the tiered shape of the sticker packages 46 allows the nature of the sticker packages 46, as well as the number of label sheet portions 42 and selected ones of the label sheet portions 42, to be quickly and easily viewed and determined. Furthermore, because the top portion 74 of the die-cut sheet 70 lies on top of the scrapbooking pages 60, the die-cut shapes 78 of the top portion 74 are immediately presented to a user when the backing sheet 12 is opened. In addition, because the top portion 74 of the die-cut sheet 70 does not fully cover or overlap the scrapbook pages 60, at least part of the underlying scrapbook pages 60 are also visible to a potential purchaser. Furthermore, the template 26 is visually presented to a potential purchaser upon opening the backing panel 12.

Thus, in one embodiment at least one of each type of scrapbooking components 46, 78, 26, 60 is visible to a potential purchaser when the backing panel 12 is in its open position. Furthermore, in the illustrated embodiment, at least one of each of the different types of scrapbooking components 46, 78, 26, 60 is simultaneously at least partially visible when the backing panel 12 is in the open position or is manipulated by a potential purchaser. In contrast, when the backing panel 12 is moved into its closed position, each of the scrapbooking components 46, 78, 26, 60 are hidden from view and protected from damage during shipping, handling, etc. In one embodiment, each of the different types of scrapbooking components 46, 78, 26, 60 can be manually separated from the backing panel 12 for use separate and apart from the backing panel.

Although the system of the present invention is illustrated in conjunction with various types of scrapbooking components, including stickers 46, scrapbooking pages 60, die-cut shapes 78 and templates 20, various other types of scrapbooking supplies or components may also or instead be utilized in the system 10, including but not limited to, writing instruments, paper cutting instruments, adhesives, brads, buttons, cardboard stock, embossing tools, fibers, cords, pockets, sheet protectors, photo corners, ribbons, sequins and tags, wallets, pockets, tags, labels, envelopes, burnishers, charms, eyelets, snaps, notecards, notepads, as well as various other scrapbooking supplies. Furthermore, the scrapbooking components can be arranged in any of a wide variety of configurations beyond that specifically shown herein. The scrapbooking components may be arranged in nearly any desired configuration in which all, or some of the scrapbooking components are visible to a user upon opening the backing panel 12. Furthermore, although the backing panel 12 is illustrated as including five panels or sections, more or fewer sections may be included as desired, including only two main panel sections that are foldable relative to each other.

Having described the invention in detail and by reference to the preferred embodiments, it will be apparent that modifications and variations thereof are possible without departing from the scope of the invention.

1. A scrapbooking supplies system comprising:
a backing panel including at least two main panel sections that are foldable relative to each other; and
a plurality of different types of scrapbooking components coupled to said backing panel, wherein each of said scrapbooking components of said plurality of different types of scrapbooking components can be manually separated from said backing panel for use separate and apart from said backing panel.

2. The system of claim 1 wherein said backing panel is pivotable between an open position and a closed position and wherein at least one of each of the different type of scrapbooking components coupled to said backing panel are simultaneously visible when said backing panel is in said open position.

3. The system of claim 2 wherein said backing panel generally covers all of said scrapbooking components coupled thereto to generally block all of said scrapbooking components from view when said backing panel is in said closed position.

4. The system of claim 1 wherein said plurality of different types of scrapbooking components includes at least two of a template, a scrapbooking page, a sticker, a die-cut shape, a writing instrument, a paper cutting instrument, an adhesive, a brad, a button, a piece of cardboard stock, an embossing tool, a fiber, a cord, a pocket, a sheet protector, a photo corner, a ribbon, a sequin and a tag.

5. The system of claim 1 wherein said plurality of different types of scrapbooking components includes at least four different types of scrapbooking components, and wherein said backing panel is movable between an open position wherein said backing panel is unfolded and a closed position wherein said backing panel is folded, and wherein at least one of each of said at least four different types of scrapbooking components are simultaneously at least partially visible when said backing panel is in said open position.

6. The system of claim 5 wherein all of said scrapbooking components coupled to said backing panel are generally blocked from view when said backing panel is in said closed position.

7. The system of claim 6 further comprising a closure mechanism coupled to said backing panel to maintain said backing panel in said closed position.

8. The system of claim 6 wherein said backing panel includes at least three main panel sections, including a central main panel section, and a left main panel section and a right main panel section pivotally coupled to opposite sides of said central main panel section, and wherein said left and right main panel sections are foldable over said central main panel section to move said backing panel into closed position, and wherein said left and right main panel sections at least partially overlap when said backing panel is in said closed position.

9. The system of claim 8 wherein at least one scrapbooking components lies on top of each of said at least three main panel sections when said backing panel is in said open position.

10. The system of claim 9 wherein said backing panel includes two end panel sections, each end panel section being pivotally coupled to different ones of left and right main panel sections, and wherein each end panel section is foldable over the associated left or right main panel section.

11. The system of claim 8 wherein said backing panel includes two main creases separating said three main panel sections, and wherein each of said scrapbooking components are coupled to said backing panel at or immediately adjacent to one of said two main creases.

12. The system of claim 11 wherein said plurality of different types of scrapbooking components includes a set of generally square scrapbooking pages having dimensions of about 12 inches by about 12 inches.

13. The system of claim 12 wherein each scrapbooking page is coupled to said backing panel along a tear guideline.

14. The system of claim 11 wherein said plurality of different types of scrapbooking components includes a set of die-cut shapes fit together and lying on top of said set of scrapbooking pages such that said set of scrapbooking pages is located between said set of die-cut shapes and one of said three main panel sections.

15. The system of claim 14 wherein said set of die-cut shapes are formed in a die-cut sheet which includes a top portion and a bottom portion with a crease formed therebetween, and wherein said set of scrapbooking pages is located between said top portion and said bottom portions of said die-cut sheet.

16. The system of claim 10 wherein at least one of said end panel sections includes a template, and wherein said template is one of said plurality of different types of scrapbooking components.

17. The system of claim 16 wherein said template is coupled to backing sheet along a template tear guide line, and wherein a user can tear along said template tear guide line to separate said template from said backing sheet.

18. The system of claim 1 wherein said plurality of different types of scrapbooking components includes a set of sticker sheets.

19. The system of claim 18 wherein said set of sticker sheets includes a set of sticker packages, each sticker package including a first label sheet portion with stickers located thereon and a second label sheet portion with stickers located thereon, said first and second label sheet portions being packaged together inside clear packaging such that said first and second label sheets are spaced apart and a gap is located between said first and second label sheet portions, and wherein said clear packaging is coupled to said backing panel at said gap.

20. A scrapbooking supplies system that is unpurchased by an end user, the supplies system comprising:
a backing panel including at least two main panel sections that are foldable relative to each other; and
a plurality of types of scrapbooking components coupled to an inner surface of said backing panel which can be manually separated from said backing panel after purchase by an end user for use separate and apart from said backing panel, wherein at least one representative scrapbooking component of each of said plurality of types of scrapbooking components is visible to a potential purchaser upon inspection and manipulation of said backing panel.

21. A method for selling scrapbooking supplies comprising:
providing a system including a backing panel having at least two main panel sections that are foldable relative to each other and a plurality of types of scrapbooking components coupled to an inner surface of said backing panel which can be manually separated from said backing panel after purchase by an end user for use separate and apart from said backing panel, wherein at least one representative scrapbooking component of each of said plurality of types of scrapbooking components is visible to a potential purchaser upon inspection and manipulation of said backing panel; and
displaying said system for retail sale such that a potential purchaser can fold and unfold said two main panel sections and inspect said plurality of types of scrapbooking components.
